(19) United States
(12) Patent Application Publication
(10) Pub. No.: US 2024/0134180 A1
(43) Pub. Date: Apr. 25, 2024

(54) OPTICAL DEVICE AND PRISM MODULE THEREOF

(71) Applicants: Sintai Optical (Shenzhen) Co., Ltd., ShenZhen City (CN); Asia Optical Co., Inc., Taichung (TW)

(72) Inventors: Fei Han, ShenZhen City (CN); Xiao-Yao Zhang, ShenZhen City (CN); Yue-Ye Chen, ShenZhen City (CN); Ling-Wei Zhao, ShenZhen City (CN); Jun-Wei Che, ShenZhen City (CN); Hua-Tang Liu, Taichung (TW)

(21) Appl. No.: 18/490,812

(22) Filed: Oct. 19, 2023

(30) Foreign Application Priority Data
Oct. 23, 2022 (TW) 11140261
Nov. 8, 2022 (CN) 202211392467.6

(51) Int. Cl. G02B 23/02; G02B 5/04

(52) U.S. Cl. CPC G02B 23/02; G02B 5/04

(57) ABSTRACT

An optical device and the prism module thereof are provided. The prism module includes a first prism, a second prism, and a third prism. The second prism is disposed beside the first prism. The third prism is adhered to the second prism. First light enters the first prism, is reflected plural times in the first prism, enters the second prism, and is emitted from the second prism. Second light enters the second prism, is reflected plural times in the second prism, and is emitted from the second prism. Third light sequentially passes through the third prism and the second prism, enters the first prism, is reflected plural times in the first prism, and is emitted from the first prism.

### BACKGROUND OF THE INVENTION

### Field of the Invention

The invention relates to an optical device and the prism module thereof.

### Description of the Related Art

Currently, a prism assembly used in rangefinder binoculars is a Schmidt-Pechan prism. If the Schmidt-Pechan prism is off-axis in arrangement, then the volume of the prism assembly will be large and the producing cost will be increased. Therefore, a design of new structure is required to address the issue.

### BRIEF SUMMARY OF THE INVENTION

An object of the invention is to provide an optical device and the prism module thereof. The prism module of the invention is off-axis in arrangement that is advantageous to installment in large aperture binoculars. The optical device has a compact structure. Due to the reduced volume, the displaying system of the optical device has a shorted light path so that the attenuation of light energy can be effectively reduced and the brightness can be promoted. Further, the light emitter and the display are disposed at two sides of the prism module to avoid light interference.

The prism module in accordance with an exemplary embodiment of the invention includes a first prism and a second prism. The first prism includes a first surface, a second surface and a third surface connected to each other. The second prism includes a first part and a second part. The first part includes a fourth surface, a fifth surface and a sixth surface connected to each other, the fourth surface is disposed towards the second surface, and the fifth surface is disposed opposite to the fourth surface. The second part includes a seventh surface, an eighth surface and a ninth surface connected to each other, the seventh surface is disposed towards the sixth surface, and the eighth surface is disposed opposite to the seventh surface. The first light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism. The second light enters the second prism through the ninth surface, is sequentially reflected on the eighth surface and the seventh surface, and exits from the eighth surface of the second prism. Except for the second prism, the second light does not pass through any prism. The second light traveling inside the second prism is reflected exactly two times.

In another exemplary embodiment, the prism module further includes a film, wherein the film is disposed adjacent to the fifth surface, the first light is visible light, the film is configured to reflect the first light, and the first light and the second light overlap when exiting from the eighth surface of the second prism.

The prism module in accordance with an exemplary embodiment of the invention includes the above-mentioned prism module, a display, an object lens unit and an eyepiece unit. The display is configured to generate the second light that is visible light. The first light entering the optical device passes through the object lens unit and enters the first prism through the first surface. The first light and the second light exiting from the eighth surface of the second prism pass through the eyepiece unit and exit from the optical device.

In another exemplary embodiment, the optical device includes the above-mentioned prism module, a display, an object lens unit and an eyepiece unit. The display is configured to generate the second light that is visible light. The first light entering the optical device passes through the object lens unit and enters the first prism through the first surface. The first light and the second light exiting from the eighth surface of the second prism pass through the eyepiece unit and exit from the optical device.

In yet another exemplary embodiment, the prism module includes a first prism, a second prism and a third prism. The first prism includes a first surface, a second surface and a third surface connected to each other. The second prism includes a first part and a second part. The third prism includes a tenth surface, an eleventh surface and a twelfth surface connected to each other. The first part includes a fourth surface, a fifth surface and a sixth surface connected to each other wherein the fourth surface is disposed towards the second surface and the fifth surface is disposed opposite to the fourth surface. The second part includes a seventh surface, an eighth surface and a ninth surface connected to each other, the seventh surface is disposed towards the sixth surface, and the eighth surface is disposed opposite to the seventh surface. The second light enters the second prism through the ninth surface, is sequentially reflected on the eighth surface and the seventh surface, and exits from the eighth surface of the second prism. The third light enters the third prism through the twelfth surface, is reflected on the eleventh surface, passes through the tenth surface, enters the second prism through the fifth surface, exits from the fourth surface of the second prism, enters the first prism through the second surface, is sequentially reflected on the first surface, the third surface and the second surface of the first prism, and exits from the first surface of the first prism.

In another exemplary embodiment, the prism module further includes a film disposed between the fifth surface and the tenth surface, wherein the third light is invisible light, and the film is configured to allow the third light to pass through.

In yet another exemplary embodiment, the optical device includes the above-mentioned prism module, a light emitter and a light receiver. The light emitter is configured to generate the third light which passes through the prism module and reaches a target object. The light receiver is configured to receive the third light after the third light is reflected by the target object.

In another exemplary embodiment, the optical device includes the above-mentioned prism module, a light emitter and a light receiver. The light emitter is configured to generate the third light which passes through the prism module and reaches a target object. The light receiver is configured to receive the third light after the third light is reflected by the target object.

In yet another exemplary embodiment, the prism module includes a film, a first prism, a second prism and a third prism. The first prism includes a first surface, a second surface and a third surface connected to each other. The second prism includes a first part and a second part. The third prism includes a tenth surface, an eleventh surface and a twelfth surface connected to each other. The first part includes a fourth surface, a fifth surface and a sixth surface connected to each other wherein the fourth surface is disposed towards the second surface and the fifth surface is disposed opposite to the fourth surface. The second part includes a seventh surface, an eighth surface and a ninth surface connected to each other, the seventh surface is disposed towards the sixth surface, and the eighth surface is disposed opposite to the seventh surface. Second light enters the second prism through the ninth surface, is sequentially reflected on the eighth surface and the seventh surface, and exits from the eighth surface of the second prism. Third light is reflected by a target object, enters the first prism through the first surface, is sequentially reflected on the second surface, the third surface and the first surface, exits from the second surface of the first prism, enters the second prism through the fourth surface, exits from the fifth surface of the second prism, enters the third prism through the tenth surface, is reflected on the eleventh surface, and exits from the twelfth surface of the third prism. The film is disposed between the fifth surface and the tenth surface, allowing the third light to pass through.

In another exemplary embodiment, the optical device includes the above-mentioned prism module, a light emitter and a light receiver. The light emitter is configured to generate the third light which reaches a target object. The light receiver is configured to receive the third light after the third light is reflected by the target object and passes through the prism module.

In yet another exemplary embodiment, the prism module includes a first prism, a second prism and a third prism. The first prism includes a first surface, a second surface and a third surface connected to each other. The second prism includes a first part and a second part. The third prism includes a tenth surface, an eleventh surface and a twelfth surface connected to each other. The first part includes a fourth surface, a fifth surface and a sixth surface connected to each other wherein the fourth surface is disposed towards the second surface and the fifth surface is disposed opposite to the fourth surface. The second part includes a seventh surface and an eighth surface connected to each other, the seventh surface is disposed towards the sixth surface, and the eighth surface is disposed opposite to the seventh surface. First light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism. Third light enters the third prism through the twelfth surface, is reflected on the eleventh surface, passes through the tenth surface, enters the second prism through the fifth surface, exits from the fourth surface of the second prism, enters the first prism through the second surface, is sequentially reflected on the first surface, the third surface and the second surface of the first prism, and exits from the first surface of the first prism.

In another exemplary embodiment, the prism module includes a first prism, a second prism and a third prism. The first prism includes a first surface, a second surface and a third surface connected to each other. The second prism includes a first part and a second part. The third prism includes a tenth surface, an eleventh surface and a twelfth surface connected to each other. The first part includes a fourth surface, a fifth surface and a sixth surface connected to each other wherein the fourth surface is disposed towards the second surface and the fifth surface is disposed opposite to the fourth surface. The second part includes a seventh surface and an eighth surface connected to each other, the seventh surface is disposed towards the sixth surface, and the eighth surface is disposed opposite to the seventh surface. First light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism. Third light is reflected by a target object, enters the first prism through the first surface, is sequentially reflected on the second surface, the third surface and the first surface, exits from the second surface of the first prism, enters the second prism through the fourth surface, exits from the fifth surface of the second prism, enters the third prism through the tenth surface, is reflected on the eleventh surface, and exits from the twelfth surface of the third prism.

In yet another exemplary embodiment, the prism module includes a first prism, a second prism and a third prism. The first prism includes a first surface, a second surface and a third surface connected to each other. The second prism includes a fourth surface, a fifth surface and a sixth surface connected to each other wherein the fourth surface is disposed towards the second surface. The third prism includes a seventh surface and an eighth surface connected to each other, wherein the seventh surface is disposed opposite to the eighth surface and the eighth surface is disposed towards the fifth surface. First light enters the first prism through the first surface, is sequentially reflected on the second surface, the third surface and the first surface, exits from the second surface of the first prism, enters the second prism through the fourth surface, is sequentially reflected on the fifth surface and the fourth surface, and exits from the sixth surface of the second prism. Second light enters the third prism through the seventh surface, exits from the eighth surface of the third prism, enters the second prism through the fifth surface, is reflected on the fourth surface, and exits from the sixth surface of the second prism.

In another exemplary embodiment, the optical device includes the above-mentioned prism module, a display, an object lens unit and an eyepiece unit. The display is configured to generate the second light. When entering the optical device, the first light passes through the object lens unit and enters the first prism through the first surface. After exiting from the sixth surface of the second prism, the first light and the second light pass through the eyepiece unit and exit from the optical device. The first light and the second light are visible light. The first light and the second light overlap when exiting from the sixth surface of the second prism. Central axes of the object lens unit and the eyepiece unit are in parallel and do not coincide.

In yet another exemplary embodiment, the optical device includes the above-mentioned prism module, a display, an object lens unit and an eyepiece unit. The display is configured to generate the second light. When entering the optical device, the first light passes through the object lens unit and enters the first prism through the first surface. After exiting from the sixth surface of the second prism, the first light and the second light pass through the eyepiece unit and exit from the optical device. The first light and the second light are visible light. Central axes of the object lens unit and the eyepiece unit are in parallel and do not coincide.

In another exemplary embodiment, the prism module further includes a fourth prism. The fourth prism includes a tenth surface, an eleventh surface and a twelfth surface connected to each other, wherein the tenth surface is disposed towards the ninth surface. The fifth surface is disposed opposite to the fourth surface. The third prism further includes a ninth surface which is connected to the eighth surface and is disposed opposite to the eighth surface. Third light enters the fourth prism through the tenth surface, is sequentially reflected on the eleventh surface and the twelfth surface, exits from the tenth surface of the fourth prism, enters the third prism through the ninth surface, exits from the eighth surface of the third prism, enters the second prism through the fifth surface, exits from the fourth surface of the second prism, enters the first prism through the second surface, is sequentially reflected on the first surface, the third surface and the second surface, and exits from the first surface of the first prism.

In yet another exemplary embodiment, the prism module further includes a film disposed between the fifth surface and the eighth surface for reflecting the first light but allowing the second light and the third light to pass through. The fourth surface and the second surface has a gap therebetween. The eleventh surface adjoins the twelfth surface.

In another exemplary embodiment, the optical device includes the above-mentioned prism module, an object lens unit and an eyepiece unit. The light emitter is configured to generate the third light which reaches a target object. The light receiver is configured to receive the third light after the third light is reflected by the target object. The prism module is disposed in a path along which the third light reaches the target object. The third light is invisible light.

In yet another exemplary embodiment, the prism module further includes a fifth prism, a sixth prism and a seventh prism. The fifth prism includes a thirteenth surface, a fourteenth surface and a fifteenth surface connected to each other. The sixth prism includes a sixteenth surface and a seventeenth surface connected to each other wherein the sixteenth surface is disposed towards the fourteenth surface, and the seventeenth surface is disposed opposite to the sixteenth surface. The seventh prism includes an eighteenth surface, a nineteenth surface and a twentieth surface connected to each other, wherein the eighteenth surface is disposed towards the seventeenth surface. Third light is reflected by a target object, enters the fifth prism through the thirteenth surface, is sequentially reflected on fourteenth surface, the fifteenth surface and thirteenth surface, exits from the fourteenth surface of the fifth prism, enters the sixth prism through the sixteenth surface, exits from the seventeenth surface of the sixth prism, enters the seventh prism through the eighteenth surface, is reflected on the nineteenth surface, and exits from the twentieth surface of the seventh prism. The third light enters the fifth prism in a first direction and exits from the twentieth surface of the seventh prism in a second direction, and the first direction is opposite to the second direction.

In another exemplary embodiment, the sixteenth surface and the fourteenth surface has a gap therebetween.

In yet another exemplary embodiment, the optical device includes the above-mentioned prism module, an object lens unit and an eyepiece unit. The light emitter is configured to generate the third light which reaches the target object. The light receiver is configured to receive the third light after the third light is reflected by the target object. The prism module is disposed in a path along which the third light reflected by the target object reaches the light receiver. The third light is invisible light.

### BRIEF DESCRIPTION OF THE DRAWINGS

FIG. 1 depicts an optical device in accordance with a first embodiment of the invention.

FIG. 2 shows a part of the optical device of FIG. 1.

FIG. 3 shows a light path of the optical device of FIG. 1, along which the first visible light travels.

FIG. 4 shows a light path of the optical device of FIG. 1, along which the second visible light travels.

FIG. 5 shows a light path of the optical device of FIG. 1, along which the invisible light travels.

FIG. 6 shows a prism module and a display of an optical device and the light paths for the first light and the second light and the light path for the third light that is emitted, in accordance with a third embodiment of the invention.

FIG. 7 is a perspective view showing the light emitter of the third embodiment and the prism module of FIG. 2.

FIG. 8 shows the prism module of the third embodiment of the invention, and the light path for the third light to be received.

### DETAILED DESCRIPTION OF THE INVENTION

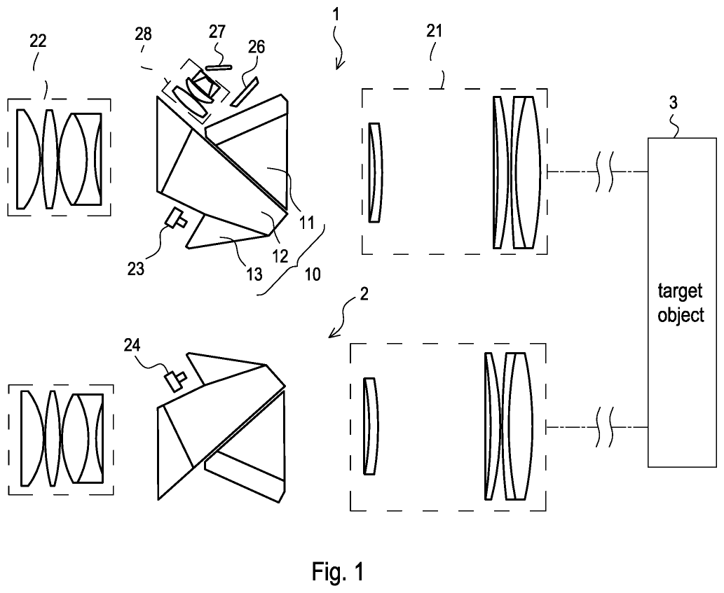

Referring to FIG. 1, the optical device in accordance with a first embodiment of the invention is rangefinder binoculars that include two optical systems 1, 2. The main differences therebetween are that the optical systems 1 is provided with a light emitter 23 while the optical system 2 is provided with a light receiver 24. Other elements and arrangements of the optical systems 1, 2 are substantially identical. For simplicity, only the optical system 1 is described with reference to the accompanying drawings in the following:

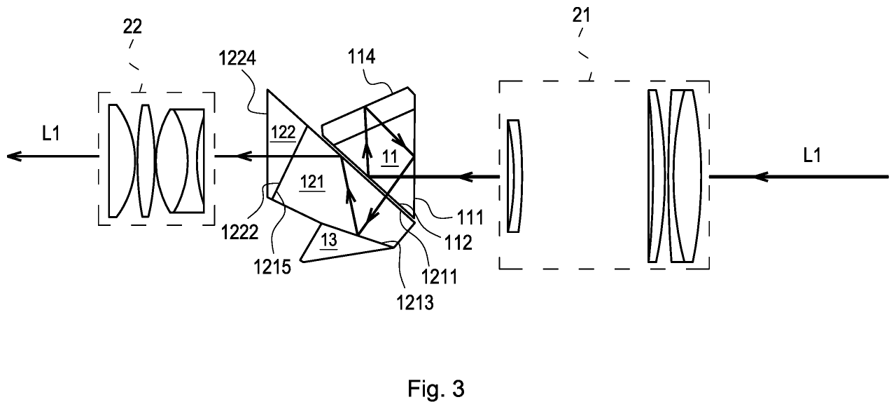

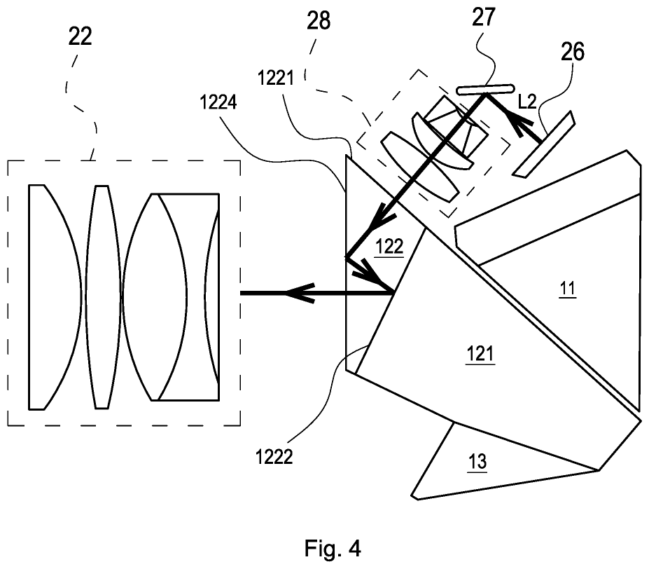

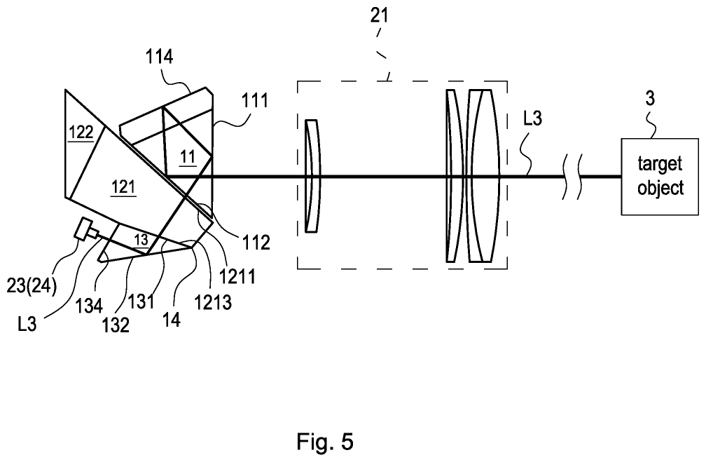

The optical system 1 includes an object lens unit 21, an eyepiece unit 22, a display 26, a reflecting mirror 27, a lens assembly 28, a prism module 10 and a light emitter 23. In operation, first light (visible light, shown in FIG. 3) sequentially passes through the object lens unit 21, the prism module 10 and the eyepiece unit 22. It can be seen from FIG. 3 that the central axes of the object lens unit 21 and the eyepiece unit 22 are in parallel and do not coincide. Second light (visible light, shown in FIG. 4) is generated by the display 26, is reflected by the reflecting mirror 27, and passes through the lens assembly 28, the prism module 10 and the eyepiece unit 22. Third light (invisible light, shown in FIG. 5) is emitted by the light emitter 23, passes through the prism module 10 and the object lens unit 21, reaches a target object 3, is reflected back to another optical system 2, and is received by the light receiver 24. Accordingly, the user is able to observe the images of the target object 3 and the images generated by the display 3 and to know the distance between the target object 3 and the rangefinder binoculars. The structure and operation of the rangefinder binoculars are described in detail in the following.

The term “connect” means “to directly connect” or “to indirectly connect”. The term “adjoin” means “to directly connect”. Therefore, when an element adjoins another element, the two elements are directly connected to each other.

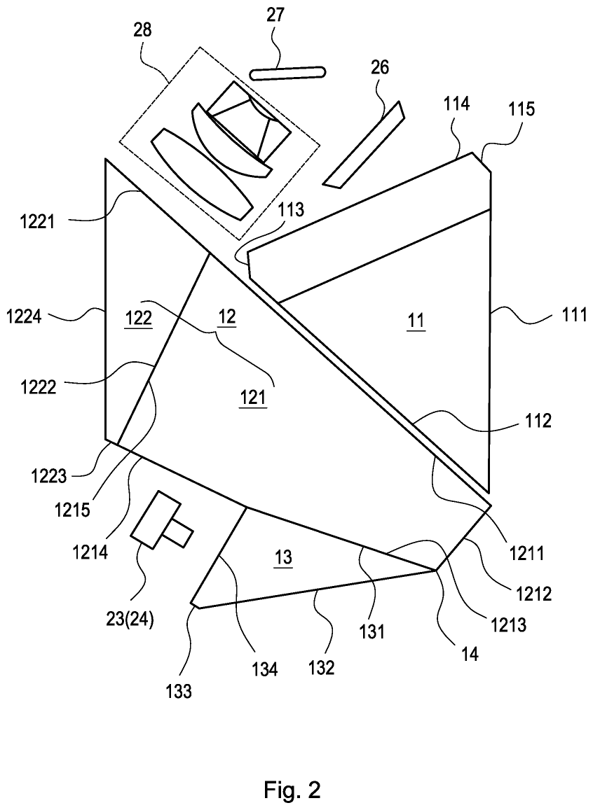

The prism module 10 is disposed between the object lens unit 21 and the eyepiece unit 22 and includes a first prism 11, a second prism 12, and a third prism 13. Referring to FIGS. 1 and 2, the first prism 11 is a roof prism and includes a first surface 111, a second surface 112, a thirteenth surface 113, a third surface 114, and a fourteenth surface 115 connected to each other. Specifically, in the first embodiment, the first surface 111 adjoins the second surface 112. The thirteenth surface 113 adjoins both of the second surface 112 and the third surface 114. The fourteenth surface 115 adjoins both of the third surface 114 and the first surface 111. It is worth noting that the third surface 114 is disposed opposite to the included angle between the first surface 111 and the second surface 112.

The second prism 12 is disposed beside the first prism 11. The first prism 11 and the second prism 12 have a gap therebetween. In the first embodiment, the second prism 12 is a half-penta prism and includes a first part 121 and a second part 122. The first part 121 includes a fourth surface 1211, a fifteenth surface 1212, a fifth surface 1213, a sixteenth surface 1214 and a sixth surface 1215. Specifically, the fourth surface 1211 is disposed towards the second surface 112. The fifteenth surface 1212 adjoins both of the fourth surface 1211 and the fifth surface 1213. The fifth surface 1213 is disposed opposite to the fourth surface 1211. The sixteenth surface 1214 adjoins the fifth surface 1213. The sixth surface 1215 adjoins both of the fourth surface 1211 and the sixteenth surface 1214. The second part 122 includes a seventh surface 1222, a seventh surface 1223, an eighth surface 1224 and a ninth surface 1221 connected to each other. Specifically, the seventh surface 1222 is disposed towards the sixth surface 1215. The eighth surface 1224 is disposed opposite to the seventh surface 1222. The ninth surface 1221 adjoins the seventh surface 1222 and the eighth surface 1224. The ninth surface 1221 is flush with the fourth surface 1211 so that the prism module 10 can be compact in structure and have a reduced volume.

In the first embodiment, a film 15 is provided between the first part 121 and the second part 122. Specifically, the film 15 is disposed between the seventh surface 1222 and the sixth surface 1215, wherein the film 15 is formed on the seventh surface 1222 or the sixth surface 1215 and then the first part 121 and the second part 122 are combined. The film 15 allows visible light that has wavelengths in a specific range to pass through but reflects invisible light that has wavelengths in another specific range, wherein the visible light is, for example, the above-mentioned first light L1 and the invisible light is, for example, the above-mentioned second light L2.

The third prism 13 is attached to the second prism 12. In the first embodiment, the third prism 13 is a triangular prism that includes a tenth surface 131, an eleventh surface 132, an eighteenth surface 133 and a twelfth surface 134. Specifically, the tenth surface 131 adjoins both of the eleventh surface 132 and the twelfth surface 134. The eighteenth surface 133 is disposed opposite to the tenth surface 131 and adjoins both of the eleventh surface 132 and the twelfth surface 134.

In the first embodiment, a film 14 is provided between the second prism 12 and the third prism 13. Specifically, the film 14 is disposed between the fifth surface 1213 and the tenth surface 131, wherein the film 14 is formed on the fifth surface 1213 or the tenth surface 131 and then the second prism 12 and the third prism 13 are combined. The film 14 allows visible light that has wavelengths in a specific range to pass through but reflects invisible light that has wavelengths in another specific range, wherein the visible light is, for example, the above-mentioned first light L1 and the invisible light is, for example, the above-mentioned third light L3.

As shown in FIG. 3, in operation, the first light L1 from the target object 3 enters the binoculars, passes through the object lens unit 21, and enters the first prism 11 through the first surface 111. In the first prism 111, the first light L1 is sequentially reflected on the second surface 112, the third surface 114 and the first surface 111 and exits from the second surface 112 of the first prism 11. Then, the first light L1 enters the second prism 12 through the fourth surface 1211. In the second prism 12, the first light L1 is sequentially reflected on the fifth surface 1213 and the fourth surface 1211, passes through the sixth surface 1215, the film 15 and the seventh surface 1222 and exits from the eighth surface 1224 of the second prism 12. Then, the first light L1 passes through the eyepiece unit 22 for the user to observe the images of the target object 3.

Referring to FIG. 4, the second light L2 is generated by the display 26, is reflected to the lens assembly 28 by the reflecting mirror 27, passes through the lens assembly 28, enters the second prism 12 through the ninth surface 1221, is sequentially reflected on the eighth surface 1224 and the seventh surface 1222, exits from the eighth surface 1224 of the second prism 12, and passes through the eyepiece unit 22 for the user to observe the images generated by the display 26.

The display 26 may be an organic light-emitting diode (OLED), a liquid crystal display (LCD) or other displaying devices.

It is worth noting that the second light L2 only passes through one prism (i.e. the second prism 12) and is reflected only twice therein. Further, the light incident surface where the second light L2 enters the second prism 12 and the light emitting surface where the second light L2 exits from the second prism 12 are different. By such arrangement, the light path in the prism module for the displaying system is shortest so as to reduce the loss of brightness.

Referring to FIG. 5, the third light L3 is emitted from the light emitter 23, enters the third prism 13 through the twelfth surface 134, is reflected on the eleventh surface 132, passthrough the tenth surface 131 and the film 14, enters the second prism 12 through the fifth surface 1213, exits from the fourth surface 1211 of the second prism 12, enters the first prism 11 through the second surface 112, is sequentially reflected on the first surface 111, the third surface 114, and the second surface 112, exits from the first surface 111 of the first prism 11, passes through the object lens unit 21 and reaches the target object 3. Then, the third light L3 is reflected back to the binoculars by the target object 3 and is received by the light receiver 24 for calculating the distance between the target object 3 and the binoculars.

The described light emitter 23 may be a laser diode (LD) or other light sources. The described light receiver 24 may be a photoelectric diode (PD), a photomultiplier tube (PMT), a charge coupled device (CCD), an avalanche photodiode (APD), a single-photon avalanche diode (SPAD) or other light detectors.

The above-mentioned “connect” may mean “directly connect” or “indirectly connect”. As shown in FIG. 2, for example, the first surface 111 and the third surface 114 are connected. Even when the fourteenth surface 115 is provided between the first surface 111 and the third surface 114, imaginary planes extending from the first surface 111 and the third surface 114 are intersected. In design, a prism may have a corner(s) or an edge(s) cut away to meet the requirements of practical space or assembly, thereby producing an additional prism surface(s) (e.g. the fourteenth surface 115, the thirteenth surface 113, the seventeenth surface 1223 and the fifteenth surface 1212). In another aspect, the first surface 111 and the second surface 112 in the first embodiment are directly connected. In some other embodiments, however, the prism may need the edge between the first surface 111 and the second surface 112 to be cut away in accordance with the practical requirements, thereby producing a new prism surface (not shown). It is understood that the new prism surface is not provided to be a part of the main optical path.

In a second embodiment, the locations of the light emitter 23 and the light receiver 24 of the optical systems 1, 2 are exchanged. In operation, the third light L3 emitted from the light emitter 23 is reflected back to the binoculars by the target object 3, passes through the object lens unit 21, enters the first prism 11 through the first surface 111, is sequentially reflected on the second surface 112, the third surface 114 and the first surface 111, exits from the second surface 112 of the first prism 11, enters the second prism 12 through the fourth surface 1211, exits from the fifth surface 1213 of the second prism 12, passes through the film 14, enters the third prism 13 through the tenth surface 131, is reflected on the eleventh surface 132, exits from the twelfth surface 134 of the third prism 13, and reaches the light receiver 24. The light receiver 24 is configured to receive the third light reflected by the target object 3, thereby calculating the distance between the target object 3 and the binoculars. Other arrangements and operation are similar to those of the first embodiment and therefore the descriptions are omitted.

According to the first embodiment and the second embodiment, the prism module includes a roof prism, a half-penta prism and a triangular prism. The roof prism is disposed beside the half-penta prism with a gap formed therebetween, and the traiangular prism is attached to the half-penta prism, thereby performing the light splitting of the distant-object viewing system, the range finding system and the displaying system. The optical device has a compact structure so as to shorten the light path in the prism module for the displaying system. Further, the prism module of the invention is off-axis in arrangement that is advantageous to installment in large aperture binoculars. Further, the light emitter and the display are disposed at two sides of the prism module to avoid light interference.

In a third embodiment of the invention, the lens modules of the optical systems 1, 2 of the optical device are modified, described in the following.

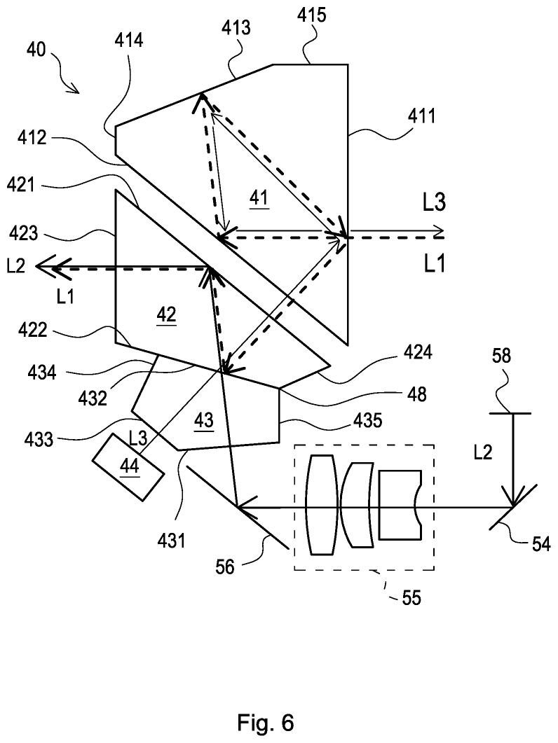

Referring to FIG. 6, the lens module 40 of the optical system 1 of the optical device includes a first prism 41, a second prism 42, a third prism 43 and a fourth prism 44. In the third embodiment, the first prism 41 is a roof prism and includes a first surface 411, a second surface 412, a twenty-first surface 414, a third surface 413 and a twenty-second surface 415 connected to each other. Specifically, the first surface 411 adjoins the second surface 412, the twenty-second surface 415 adjoins both of the first surface 411 and the third surface 413, and the twenty-first surface 414 adjoins both of the second surface 412 and the third surface 413. The third surface 413 is disposed opposite to the included angle between the first surface 411 and the second surface 412.

The second prism 42 is disposed beside the first prism 41, with a gap provided therebetween. In the third embodiment, the second prism 42 is a half-penta prism and includes a fourth surface 421, a sixth surface 423, a fifth surface 422 and a twenty-third surface 424 connected to each other. Specifically, the fourth surface 421 is disposed towards the second surface 412 and a gap is formed between the fourth surface 421 and the second surface 412. The sixth surface 423 adjoins both of the fourth surface 421 and the fifth surface 422. The twenty-third surface 424 adjoins both of the fourth surface 421 and the fifth surface 422.

The third prism 43 is attached to the second prism 42. In the third embodiment, the third prism 43 is a light splitting prism and includes a seventh surface 431, a ninth surface 433, a twenty-fourth surface 434, an eighth surface 432 and a twenty-fifth surface 435 connected to each other. Specifically, the eighth surface 432 is disposed towards the fifth surface 422. The twenty-fifth surface 435 adjoins both of the eighth surface 432 and the seventh surface 431. The twenty-fourth surface 434 adjoins both of the eighth surface 432 and the ninth surface 433. The seventh surface 431 adjoins the ninth surface 433. The eighth surface 432 is disposed opposite to the seventh surface 431 and the ninth surface 433.

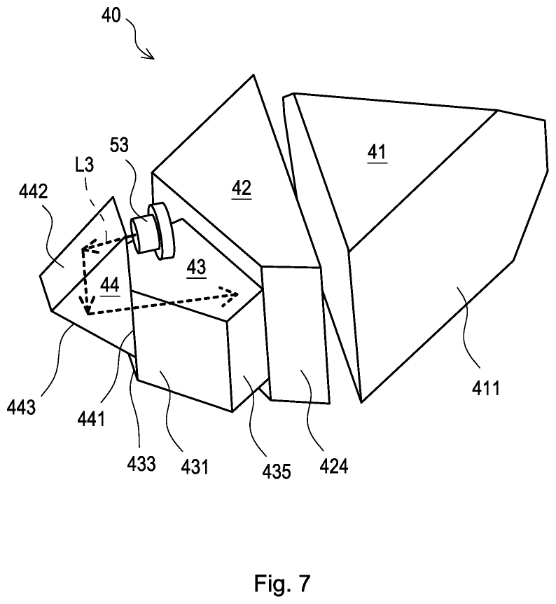

The fourth prism 44 is disposed besides the third prism 43, with a gap formed therebetween. Referring to FIG. 7, in the third embodiment, the fourth prism 44 is a triangular prism and includes tenth surface 441, an eleventh surface 442 and a twelfth surface 443 connected to each other. Specifically, the tenth surface 441 is disposed towards the ninth surface 433 and adjoins both of the eleventh surface 442 and the twelfth surface 443. The eleventh surface 442 adjoins the twelfth surface 443.

In the third embodiment, a film 48 is provided between the second prism 42 and the third prism 43. Specifically, the film 48 is provided between the fifth surface 422 and the eighth surface 432, wherein the film 48 is formed on the fifth surface 422 or the eighth surface 432 and then the second prism 42 and the third prism 43 are combined. The film 48 allows invisible light that has wavelengths in a specific range (e.g. the third light L3 mentioned above) to pass through but reflects visible light that has wavelengths in another specific range (e.g. the first light L1 mentioned above).

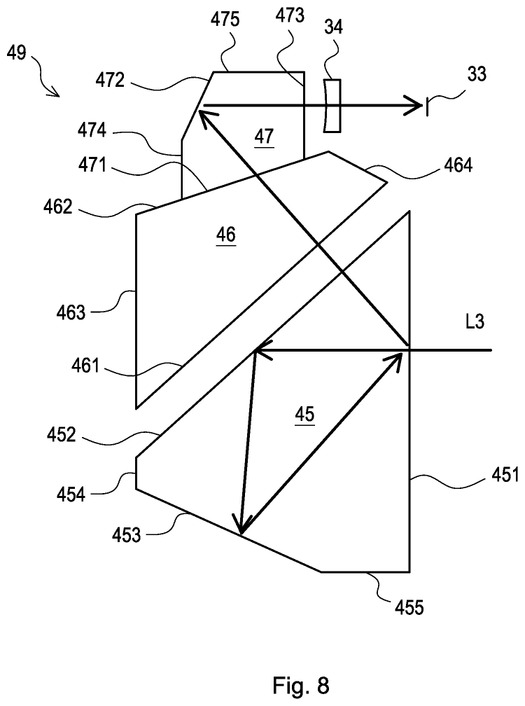

Referring to FIG. 8, the prism module 49 of the optical system 2 of the optical device includes a fifth prism 45, a sixth prism 46 and a seventh prism 47. The fifth prism 45 and the first prism 41 have the same shape and are placed in a symmetrical arrangement. Similarly, the sixth prism 46 and the second prism 42 have the same shape and are placed in a symmetrical arrangement.

In the third embodiment, the fifth prism 45 is a roof prism and includes a thirteenth surface 451, a fourteenth surface 452, a twenty-sixth surface 454, a fifteenth surface 453 and a twenty-seventh surface 455 connected to each other. Specifically, the thirteenth surface 451 adjoins the fourteenth surface 452, the twenty-seventh surface 455 adjoins both of the thirteenth surface 451 and the fifteenth surface 453, and the twenty-sixth surface 454 adjoins both of the fourteenth surface 452 and the fifteenth surface 453. The fifteenth surface 453 is disposed opposite to the included angle between the thirteenth surface 451 and the fourteenth surface 452.

The sixth prism 46 is disposed beside the fifth prism 45, with a gap provided therebetween. In the third embodiment, the sixth prism 46 is a half-penta prism and includes a sixteenth surface 461, a twenty-eighth surface 463, a seventeenth surface 462 and a twenty-ninth surface 464 connected to each other. Specifically, the sixteenth surface 461 is disposed towards the fourteenth surface 452 and a gap is formed between the sixteenth surface 461 and the fourteenth surface 452. The twenty-eighth surface 463 adjoins both of the sixteenth surface 461 and the seventeenth surface 462. The twenty-ninth surface 464 adjoins both of the sixteenth surface 461 and the seventeenth surface 462. The seventh prism 47 is attached to the sixth prism 46. In the third embodiment, the seventh prism 47 is a light splitting prism and includes an eighteenth surface 471, a twentieth surface 473, a thirty-first surface 475, a nineteenth surface 472 and a thirtieth surface 474 connected to each other. Specifically, the eighteenth surface 472 is disposed towards the seventeenth surface 462. The twentieth surface 473 adjoins both of the eighteenth surface 471 and the thirty-first surface 475. The nineteenth surface 472 adjoins both of the thirty-first surface 475 and the thirtieth surface 474 and is disposed opposite to the included angle between the eighteenth surface 471 and the twentieth surface 473. The thirtieth surface 474 adjoins both of the eighteenth surface 471 and the nineteenth surface 472 and is disposed opposite to the included angle between the twentieth surface 473 and the thirty-first surface 475.

The first light L1 from the target object enters the optical device. In the optical system 1, the first light L1 passes through the object lens unit and enters the lens module 40. As shown in FIG. 6, the first light L1 enters the first prism 41 through the first surface 411, is sequentially reflected on the second surface 412, the third surface 413 and the first surface 411, exits from the second surface 412 of the first prism 41, enters the second prism 42 through the fourth surface 421, is sequentially reflected on the fifth surface 422 and the fourth surface 421, exits from the sixth surface 423 of the second prism 42, and passes though the eyepiece unit for the user to observe the images of the target object. The fifth prism 45 and the sixth prism 46 of the optical system 2 are respectively the same as the first prism 41 and the second prism 42 of the optical system 1 in shape. Further, they are placed in a symmetrical arrangement so that their light paths are similar. Therefore, the descriptions thereof are omitted.

The second light L2 is emitted by the display 58, is reflected to the lens assembly 55 by the reflecting mirror 54, and is reflected to the lens module 40 by the reflecting mirror 56. The second light L2 enters the third prism 43 through the seventh surface 431, exits from the eighth surface 432 of the third prism 43, passes through the film 48, enters the second prism 42 through the fifth surface 422, is reflected on the fourth surface 421, exits from the sixth surface 423 of the second prism 42, and passes through the eyepiece unit for the user to observe the images generated by the display 58.

It is worth noting that the first light L1 and the second light L2 overlap when exiting from the sixth surface 423 of the second prism 42.

In the optical system 1, the third light L3 is emitted by the light emitter 53, enters the fourth prism 44 through the tenth surface 441, is sequentially reflected on the eleventh surface 442 and the twelfth surface 443, exits from the tenth surface 441 of the fourth prism 44, enters the third prism 43 through the ninth surface 433, exits from the eighth surface 432 of the third prism 43, passes through the film 48, enters the second prism 42 through the fifth surface 422, exits from the fourth surface 421 of the second prism 42, enters the first prism 41 through the second surface 412, is sequentially reflected on the first surface 411, the third surface 413 and the second surface 412, and exits from the first surface 411 of the first prism 41. Then, the third light L3 passes through the object lens unit, reaches the target object, and is reflected back to the optical device by the target object.

The third light L3 reflected back to the optical device enters the optical system 2, in which the third light L3 passes through the object lens unit and reaches the lens module 49. As shown in FIG. 8, the third light L3 enters the fifth prism 45 through the thirteenth surface 451, is sequentially reflected on the fourteenth surface 452, the fifteenth surface 453 and the thirteenth surface 451, exits from the fourteenth surface 452 of the fifth prism 45, enters the sixth prism 46 through the sixteenth surface 461, exits from the seventeenth surface 462 of the sixth prism 46, enters the seventh prism 47 through the eighteenth 471, is reflected on the nineteenth surface 472, exits from the twentieth surface 473 of the seventh prism 47, passes through the receiving lens 34, and is received by the light receiver 33. Then, the distance between the optical device and the target object can be calculated. It is worth noting that the third light L3 enters the fifth prism 45 in a first direction and exits from the twentieth surface 473 of the seventh prism 47 in a second direction, and the first direction is opposite to the second direction. By such arrangement, the prism module 40 can be compact in structure and have a reduced volume.

According to the third embodiment, the prism module includes a roof prism, a half-penta prism, a light splitting prism and a triangular prism. The roof prism is disposed beside the half-penta prism with a gap formed therebetween, the light splitting prism is attached to the half-penta prism, and the traiangular prism is disposed besides the light splitting prism. By such arrangement, the light splitting of the distant-object viewing system, the range finding system and the displaying system can be performed. The optical device has a compact structure to shorten the light path in the prism module for the displaying system so as to promote the brightness. Further, the prism module of the invention is off-axis in arrangement that is advantageous to installment in large aperture binoculars.

In conclusion, the invention provides a prism module that has a compact structure. In operation, the second light L2 does not pass through the first prism, the first light L1 passes through the first prism and the second prism, and the third light L3 passes through all the prisms.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements. In the claims, the designation of first prism, second prism, . . . , and seventh prism is only nominal and the limitations to the flow of a first prism, a second prism, . . . , and a seventh prism does not establish a specific structural relationship to distinguish these prisms. When “an optical device comprising a fifth prism” is recited in a claim and none of “a first prism”, “a second prism”, “a third prism”, “a fourth prism” and “a fifth prism” is recited in the claim, it means the optical device at least has the fifth prism. It does not mean that the optical device must have a first prism, a second prism, a third prism and a fourth prism. Similarly, in the claims, the designation of first surface, second surface, . . . , and twentieth surface is only nominal and does not establish a specific structural relationship to distinguish these surfaces.

What is claimed is:

1. A prism module, comprising:
a first prism comprising a first surface, a second surface and a third surface connected to each other;
a second prism comprising a first part and a second part;
wherein the first part comprises a fourth surface, a fifth surface and a sixth surface connected to each other, the fourth surface is disposed towards the second surface, and the fifth surface is disposed opposite to the fourth surface;
wherein the second part comprises a seventh surface, an eighth surface and a ninth surface connected to each other, the seventh surface is disposed towards the sixth surface, and the eighth surface is disposed opposite to the seventh surface;
wherein first light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism;
wherein second light enters the second prism through the ninth surface, is sequentially reflected on the eighth surface and the seventh surface, and exits from the eighth surface of the second prism;
wherein except for the second prism the second light does not pass through any prism;
wherein the second light traveling inside the second prism is reflected exactly two times.

2. The prism module as claimed in claim 1, further comprising a film, wherein the film is disposed adjacent to the fifth surface, the first light is visible light, the film is configured to reflect the first light, and the first light and the second light overlap when exiting from the eighth surface of the second prism.

3. An optical device, comprising:
the prism module as claimed in claim 2;
a display configured to generate the second light that is visible light;
an object lens unit wherein the first light entering the optical device passes through the object lens unit and enters the first prism through the first surface;
an eyepiece unit wherein the first light and the second light exiting from the eighth surface of the second prism pass through the eyepiece unit and exit from the optical device.

4. An optical device, comprising:
the prism module as claimed in claim 1;
a display configured to generate the second light that is visible light;
an object lens unit wherein the first light entering the optical device passes through the object lens unit and enters the first prism through the first surface;
an eyepiece unit wherein the first light and the second light exiting from the eighth surface of the second prism pass through the eyepiece unit and exit from the optical device.

5. A prism module, comprising:
a first prism comprising a first surface, a second surface and a third surface connected to each other;
a second prism comprising a first part and a second part;
a third prism comprising a tenth surface, an eleventh surface and a twelfth surface connected to each other;
wherein the first part comprises a fourth surface, a fifth surface and a sixth surface connected to each other wherein the fourth surface is disposed towards the second surface and the fifth surface is disposed opposite to the fourth surface;
wherein the second part comprises a seventh surface, an eighth surface and a ninth surface connected to each other, the seventh surface is disposed towards the sixth surface, and the eighth surface is disposed opposite to the seventh surface;
wherein second light enters the second prism through the ninth surface, is sequentially reflected on the eighth surface and the seventh surface, and exits from the eighth surface of the second prism;
wherein third light enters the third prism through the twelfth surface, is reflected on the eleventh surface, passes through the tenth surface, enters the second prism through the fifth surface, exits from the fourth surface of the second prism, enters the first prism through the second surface, is sequentially reflected on the first surface, the third surface and the second surface of the first prism, and exits from the first surface of the first prism.

6. The prism module as claimed in claim 5, further comprising a film disposed between the fifth surface and the tenth surface, wherein the third light is invisible light, and the film is configured to allow the third light to pass through.

7. An optical device, comprising:
the prism module as claimed in claim 6;
a light emitter configured to generate the third light which passes through the prism module and reaches a target object;
a light receiver configured to receive the third light after the third light is reflected by the target object.

8. An optical device, comprising:
the prism module as claimed in claim 5;
a light emitter configured to generate the third light which passes through the prism module and reaches a target object;
a light receiver configured to receive the third light after the third light is reflected by the target object.

9. A prism module, comprising:
a film;
a first prism comprising a first surface, a second surface and a third surface connected to each other;
a second prism comprising a first part and a second part;
a third prism comprising a tenth surface, an eleventh surface and a twelfth surface connected to each other;
wherein the first part comprises a fourth surface, a fifth surface and a sixth surface connected to each other wherein the fourth surface is disposed towards the second surface and the fifth surface is disposed opposite to the fourth surface;
wherein the second part comprises a seventh surface, an eighth surface and a ninth surface connected to each other, the seventh surface is disposed towards the sixth surface, and the eighth surface is disposed opposite to the seventh surface;
wherein second light enters the second prism through the ninth surface, is sequentially reflected on the eighth surface and the seventh surface, and exits from the eighth surface of the second prism;
wherein third light is reflected by a target object, enters the first prism through the first surface, is sequentially reflected on the second surface, the third surface and the first surface, exits from the second surface of the first prism, enters the second prism through the fourth surface, exits from the fifth surface of the second prism, enters the third prism through the tenth surface, is reflected on the eleventh surface, and exits from the twelfth surface of the third prism;
wherein the film is disposed between the fifth surface and the tenth surface, allowing the third light to pass through.

10. An optical device, comprising:
the prism module as claimed in claim 9;
a light emitter configured to generate the third light which reaches a target object;
a light receiver configured to receive the third light after the third light is reflected by the target object and passes through the prism module.

11. A prism module, comprising:
a first prism comprising a first surface, a second surface and a third surface connected to each other;
a second prism comprising a first part and a second part;
a third prism comprising a tenth surface, an eleventh surface and a twelfth surface connected to each other;
wherein the first part comprises a fourth surface, a fifth surface and a sixth surface connected to each other wherein the fourth surface is disposed towards the second surface and the fifth surface is disposed opposite to the fourth surface;
wherein the second part comprises a seventh surface and an eighth surface connected to each other, the seventh surface is disposed towards the sixth surface, and the eighth surface is disposed opposite to the seventh surface;
wherein first light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism;
wherein third light enters the third prism through the twelfth surface, is reflected on the eleventh surface, passes through the tenth surface, enters the second prism through the fifth surface, exits from the fourth surface of the second prism, enters the first prism through the second surface, is sequentially reflected on the first surface, the third surface and the second surface of the first prism, and exits from the first surface of the first prism.

12. A prism module, comprising:
a first prism comprising a first surface, a second surface and a third surface connected to each other;
a second prism comprising a first part and a second part;
a third prism comprising a tenth surface, an eleventh surface and a twelfth surface connected to each other;
wherein the first part comprises a fourth surface, a fifth surface and a sixth surface connected to each other wherein the fourth surface is disposed towards the second surface and the fifth surface is disposed opposite to the fourth surface;
wherein the second part comprises a seventh surface and an eighth surface connected to each other, the seventh surface is disposed towards the sixth surface, and the eighth surface is disposed opposite to the seventh surface;
wherein first light enters the first prism through the first surface, is sequentially reflected on the second surface, the third surface and the first surface, exits from the second surface of the first prism, enters the second prism through the fourth surface, is sequentially reflected on the fifth surface and the fourth surface, sequentially passes through the sixth surface and the seventh surface, and exits from the eighth surface of the second prism;
wherein third light is reflected by a target object, enters the first prism through the first surface, is sequentially reflected on the second surface, the third surface and the first surface, exits from the second surface of the first prism, enters the second prism through the fourth surface, exits from the fifth surface of the second prism, enters the third prism through the tenth surface, is reflected on the eleventh surface, and exits from the twelfth surface of the third prism.

13. A prism module, comprising:
a first prism comprising a first surface, a second surface and a third surface connected to each other;
a second prism comprising a fourth surface, a fifth surface and a sixth surface connected to each other wherein the fourth surface is disposed towards the second surface;
a third prism comprises a seventh surface and an eighth surface connected to each other, wherein the seventh surface is disposed opposite to the eighth surface and the eighth surface is disposed towards the fifth surface;
wherein first light enters the first prism through the first surface, is sequentially reflected on the second surface, the third surface and the first surface, exits from the second surface of the first prism, enters the second prism through the fourth surface, is sequentially reflected on the fifth surface and the fourth surface, and exits from the sixth surface of the second prism;
wherein second light enters the third prism through the seventh surface, exits from the eighth surface of the third prism, enters the second prism through the fifth surface, is reflected on the fourth surface, and exits from the sixth surface of the second prism.

14. An optical device, comprising:
the prism module as claimed in claim 13;
a display configured to generate the second light;
an object lens unit wherein, when entering the optical device, the first light passes through the object lens unit and enters the first prism through the first surface;
an eyepiece unit wherein, after exiting from the sixth surface of the second prism, the first light and the second light pass through the eyepiece unit and exit from the optical device;
wherein the first light and the second light are visible light;
wherein the first light and the second light overlap when exiting from the sixth surface of the second prism;
wherein central axes of the object lens unit and the eyepiece unit are in parallel and do not coincide.

15. An optical device, comprising:
the prism module as claimed in claim 13;
a display configured to generate the second light;
an object lens unit wherein, when entering the optical device, the first light passes through the object lens unit and enters the first prism through the first surface;
an eyepiece unit wherein, after exiting from the sixth surface of the second prism, the first light and the second light pass through the eyepiece unit and exit from the optical device;
wherein the first light and the second light are visible light;
wherein central axes of the object lens unit and the eyepiece unit are in parallel and do not coincide.

16. A prism module as claimed in claim 13, further comprising:
a fourth prism comprising a tenth surface, an eleventh surface and a twelfth surface connected to each other, wherein the tenth surface is disposed towards the ninth surface;
wherein the fifth surface is disposed opposite to the fourth surface;
wherein the third prism further comprises a ninth surface which is connected to the eighth surface and is disposed opposite to the eighth surface;
wherein third light enters the fourth prism through the tenth surface, is sequentially reflected on the eleventh surface and the twelfth surface, exits from the tenth surface of the fourth prism, enters the third prism through the ninth surface, exits from the eighth surface of the third prism, enters the second prism through the fifth surface, exits from the fourth surface of the second prism, enters the first prism through the second surface, is sequentially reflected on the first surface, the third surface and the second surface, and exits from the first surface of the first prism.

17. The prism module as claimed as claim 16, further comprising:
a film disposed between the fifth surface and the eighth surface for reflecting the first light but allowing the second light and the third light to pass through;
wherein the fourth surface and the second surface has a gap therebetween;
wherein the eleventh surface adjoins the twelfth surface.

18. An optical device, comprising:
the prism module as claimed in claim 16;
a light emitter configured to generate the third light which reaches a target object;
a light receiver configured to receive the third light after the third light is reflected by the target object;
wherein the prism module is disposed in a path along which the third light reaches the target object;
wherein the third light is invisible light.

19. The prism module as claimed in claim 13, further comprising:
a fifth prism comprising a thirteenth surface, a fourteenth surface and a fifteenth surface connected to each other;
a sixth prism comprising a sixteenth surface and a seventeenth surface connected to each other wherein the sixteenth surface is disposed towards the fourteenth surface, and the seventeenth surface is disposed opposite to the sixteenth surface;
a seventh prism comprises an eighteenth surface, a nineteenth surface and a twentieth surface connected to each other, wherein the eighteenth surface is disposed towards the seventeenth surface;
wherein third light is reflected by a target object, enters the fifth prism through the thirteenth surface, is sequentially reflected on fourteenth surface, the fifteenth surface and thirteenth surface, exits from the fourteenth surface of the fifth prism, enters the sixth prism through the sixteenth surface, exits from the seventeenth surface of the sixth prism, enters the seventh prism through the eighteenth surface, is reflected on the nineteenth surface, and exits from the twentieth surface of the seventh prism;
wherein the third light enters the fifth prism in a first direction and exits from the twentieth surface of the seventh prism in a second direction, and the first direction is opposite to the second direction.

20. The prism module as claimed as claim 19, wherein the sixteenth surface and the fourteenth surface has a gap therebetween.

21. An optical device, comprising:
the prism module as claimed in claim 19;
a light emitter configured to generate the third light which reaches the target object;
a light receiver configured to receive the third light after the third light is reflected by the target object;
wherein the prism module is disposed in a path along which the third light reflected by the target object reaches the light receiver;
wherein the third light is invisible light.
